(19) United States
(12) Patent Application Publication
(10) Pub. No.: US 2022/0327392 A1
(43) Pub. Date: Oct. 13, 2022

(54) PUZZLE VALIDATION USING HEURISTIC EVALUATION

(71) Applicant: Electronic Arts Inc., Redwood City, CA (US)

(72) Inventors: Jesse Hans Stokes Harder, Oakland, CA (US); Karine Andranikovna Levonyan, Santa Clara, CA (US); Mohsen Sardari, Burlingame, CA (US)

(73) Assignee: Electronic Arts Inc., Redwood City, CA (US)

(21) Appl. No.: 17/643,106

(22) Filed: Dec. 7, 2021

Related U.S. Application Data
(60) Provisional application No. 63/172,527, filed on Apr. 8, 2021.

(51) Int. Cl. G06N 3/12; A63F 13/60

(52) U.S. Cl. CPC G06N 3/126; A63F 13/60; A63F 2300/6009

(57) ABSTRACT

A puzzle validation system and method determine whether one or more solutions to a puzzle to be validated exist. If one or more solutions for the puzzle do exist, then the puzzle is valid. The puzzle validation system may use a path traversing algorithm that limits selections along the path to only valid selections may be implemented to find valid solutions to the puzzle that do not violate any constraints of the puzzle. The puzzle validation mechanism may also heuristically optimize, using an initial set of valid solutions, to produce optimal or near-optimal solutions to the puzzle. The puzzle validation mechanism may further generate one or more statistics associated with the puzzle that may be used to evaluated solutions when the puzzle is deployed for gameplay. The mechanisms disclosed allow for deployment of confirmed valid puzzles, either as a standalone puzzle or as a puzzle incorporated in a video game.

### BACKGROUND

Electronic puzzles, either free-standing or within a video game, are often used for entertainment purposes. These puzzles may be of any suitable type, such as arranging a group of items in a collection (e.g., a combination or permutation problem). These puzzles often include both linear and non-linear constraints, resulting in an NP-hard problem to validate these puzzles. Validating electronic puzzles, particularly difficult electronic puzzles, may use significant human resources. Validation by human validators may not be ideal, at least for the reason that such manual validation may be relatively burdensome. Even with human solution finding and/or puzzle validation, it is not always known how good the final solution is compared to solutions that had not been solved by a human validator.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates a schematic diagram of an example environment with client system(s), online gaming system(s), and/or puzzle validation system(s) to enable validation and/or deployment of puzzles, in accordance with example embodiments of the disclosure.

FIG. 2 illustrates a flow diagram of an example method by which a puzzle is validated, in accordance with example embodiments of the disclosure.

FIG. 3 illustrates an example puzzle that may be validated, in accordance with example embodiments of the disclosure.

FIG. 4 illustrates a flow diagram of an example method for determining an initial population of solutions to a puzzle, in accordance with example embodiments of the disclosure.

FIG. 5 illustrates a flow diagram of an example method for determining one or more optimized solutions of a puzzle and/or statistics associated with the puzzle, in accordance with example embodiments of the disclosure.

FIG. 6 illustrates a block diagram of an example puzzle validation system(s) that may validate a puzzle, in accordance with example embodiments of the disclosure.

### DETAILED DESCRIPTION

Example embodiments of this disclosure describes methods, apparatuses, computer-readable media, and system(s) for validating and/or evaluating freestanding and/or in-game puzzles A developer may develop a puzzle that may be played by players as a standalone puzzle and/or a puzzle embedded within a video game, such as a video game hosted on a client device or hosted on a remote online gaming system. The developer may wish to validate the puzzle to determine whether the puzzle is solvable. The developer may further wish to identify possible and/or likely performance metrics (e.g., puzzle score) for the puzzle being validated.

Before a puzzle can be deployed for play by players (e.g., customers), the puzzle may be validated to determine whether there are viable solutions to the puzzle. Furthermore, the possible gradations of the quality of various solutions may be used to evaluate solutions presented by players of the puzzle. The validation and/or different levels of solutions of the puzzle may be determined by the mechanisms discussed herein. The puzzle may be of any suitable type, such as any type of puzzle that requires making a combination and/or permutation of objects. For example, a puzzle may require a player to place a subset of objects from a relatively large choice of objects, in a particular sequence. An example of the aforementioned puzzle may be the SQUAD BUILDING CHALLENGE in FIFA 22 by ELECTRONIC ARTS of Redwood City, Calif.

The types of puzzles, as discussed herein, may have a very large number of unique solutions (e.g., greater than 10²⁰ solutions). As a result, it may be impossible and/or impractical to test every solution for validation of these puzzles. Additionally, it may be time consuming, and therefore expensive, for humans to find optimal solution(s) to these puzzles. Furthermore, any incomplete and/or non-optimizing solution to these puzzles may leave a possibility that the most optimal solution, or at least near-optimal solution(s), has not been found in the process of validation. The mechanisms discussed herein allow for finding optimal and/or near optimal solutions to puzzles that may include a large set of potential solutions. As used herein, optimal or near-optimal solutions refer to solutions that meet or exceed a determined and/or predetermined criteria or thresholds. Some examples of optimal solutions out of all solutions that satisfy puzzle constrains could be ones that contain the cheapest possible combination of items used and/or the shortest path route, such as in a “Traveling Salesman” problem. In some cases, the near-optimal solution may perform better, according to a metric associated with the puzzle, than an initial pre-optimized solution. In other examples, the near-optimal solution may be one where a puzzle score may exceed a numerical score, such as 80 out of 100. In some further cases, the near-optimal solution, as used herein, refers to the most optimal solution found by performing the optimizing techniques discussed herein. Furthermore, the mechanisms herein may provide one or more statistics associated with the puzzle. The statistics may be of any suitable type, such as a metric associated with an near-optimal solution (e.g., a high score), a metric associated with an average solution (e.g., an average score), a binary indication of whether the puzzle is solvable, or the like.

The mechanism, as discussed herein, may include a puzzle validation system receiving a variety of information about the puzzle that is to be validated. This information may include a definition of the puzzle, an objective of the puzzle, constraint(s) of the puzzle, a search space of the puzzle, or the like. The validation system may use the information about the puzzle to generate a number of initial solutions to the puzzle. The initial solutions may be such that they do not violate any constraints of the puzzle In other words, these initial solution(s) have to obey all the rules of the puzzle, even if they are not near-optimal solutions.

The validation system, after generating the initial solution(s) to the puzzle, may perform an optimization to find a more optimal or near-optimal solution to the puzzle. This optimization, therefore, may attempt to minimize or maximize a performance metric, such as a cost or a puzzle score. For example, a particular puzzle may have as an objective to maximize points that are based on the placement of objects in a pattern. Thus, the puzzle validation system may perform a heuristic optimization that maximizes, or at least increases, the points in this puzzle Such heuristic techniques may, in general, generate multiple solutions and evaluate those solutions to identify which ones of those solutions are better than other solutions. Those “better” solutions may be used in an iterative manner to generate more solutions that are then evaluated to attempt to identify even better performing solutions. In some ways, heuristic optimization may mimic the mechanism by which the human mind may attempt to optimize a solution. Any suitable heuristic mechanism may be used to find near-optimal solutions to the puzzle, such as genetic algorithms, swarm algorithms, etc.

According to examples of the disclosure, a heuristic technique may be used that uses aspects of genetic algorithms. The solutions, such as the initial solutions identified by the puzzle validation systems, may be arranged as a data structure, also referred to as a chromosome, with decision variables, also referred to as genes, therein. For example, in the case of a puzzle involving arranging objects in a particular pattern, an individual gene may represent a particular object in a particular location of the pattern. Similarly, the other positions and/or objects are represented by other genes. The collection of these genes associated with a particular solution may be arranged as a chromosome. Arranging the solutions in this manner of chromosomes, with constituent genes, enables applying biological operators (selection, cross-over, mutations, etc.) to generate child solutions that are to be evaluated to determine if those child solutions are an improvement with respect to a metric associated with the puzzle to be validated.

The puzzle validation system may use the initial chromosomes to generate more optimized solutions, such as in an iterative manner using aspects of genetic algorithms over multiple generations (e.g., by evaluating multiple child populations of chromosomes derived from parent populations of chromosomes). Although the disclosure describes the heuristic techniques in the context of genetic techniques, it should be understood that other heuristic techniques (e.g., swarm algorithms) may be used to generate improved and/or near-optimal solutions to the puzzle that is to be validated.

After validation is performed on the puzzle, the puzzle validation system may provide additional statistics related to the puzzle. For example, the statistics may simply indicate whether the puzzle is solvable. If the puzzle validation system is successful in finding even one valid solution (e.g., a solution that does not violate any constraints and/or rules of the puzzle), then it may, in effect, validate the puzzle In other words, the puzzle validation system may be configured to indicate if the puzzle has at least one valid solution. In some cases, the puzzle validation system may be configured to provide a richer set of information associated with the puzzle being validated. The statistics associated with the puzzle may be used for any variety of purposes, such as to assess how hard or easy the puzzle being evaluated is, or to determine a benchmark by which to evaluate solutions by human players during gameplay. For example, the statistics may provide an idea of how plausible it is to derive a valid solution to the puzzle. In some cases, even if a solution is possible, but if it would be extremely hard for a human player to derive a valid solution, that puzzle may not be usable, even though it is technically solvable. The statistics may alternatively be used to evaluate the quality of potential human solutions when the puzzle is deployed for gameplay.

As an example of using the statistics, as may be generated by the puzzle validation system, consider that the puzzle validation system indicates that for a particular puzzle being evaluated, a single valid solution was derived (e.g., by way of generating the initial solution) after evaluation of a large number of evaluations of potential solutions that a human would not be capable of A developer of the puzzle may determine that in this case, the puzzle ought not be deployed, as the puzzle would be too frustrating and most people, if not all people, would not be able to derive a solution to the puzzle, even though a solution exists.

As another example of the use of statistics associated with the puzzle, the puzzle validation system may provide an indication of the ease in finding solutions with a particular range of a performance metric. For example, the puzzle validation system may indicate that it found 5 solutions to a puzzle that produced a score between 80 and 100. The puzzle validation system may further indicate that it found 27 solutions with a score in the range of 70 and 79, 46 solutions resulting in a score in the range of 60 and 69, and 114 solutions that result in a score of less than 60. When the puzzle is deployed for gameplay, either as a standalone puzzle or as an embedded puzzle in another video game, the evaluation of solutions may indicate that scores better than 79 may be outstanding, the range of 70 to 79 may be good, the range of 60-69 may be fair, and scores less than 60 may be poor performance on the puzzle.

Certain implementations and embodiments of the disclosure will now be described more fully below with reference to the accompanying figures, in which various aspects are shown. However, the various aspects may be implemented in many different forms and should not be construed as limited to the implementations set forth herein. It will be appreciated that the disclosure encompasses variations of the embodiments, as described herein. Like numbers refer to like elements throughout.

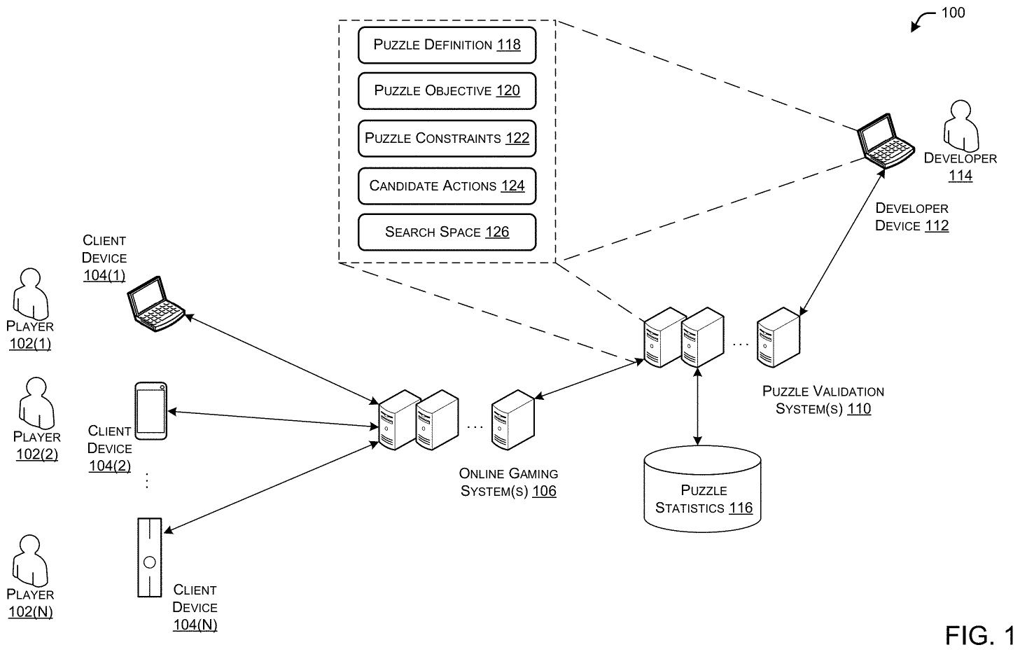

FIG. 1 illustrates a schematic diagram of an example environment 100 with client device(s) 104, online gaming system(s) 106, and/or puzzle validation system(s) 110 to enable validation and/or deployment of puzzles, in accordance with example embodiments of the disclosure. The example environment 100 includes one or more player(s) 102(1), 102(2), . . . 102(N), hereinafter referred to individually or collectively as player 102 or player(s) 102, who may interact with respective client device(s) 104(1), 104(2), . . . 104(N), hereinafter referred to individually or collectively as client device 104 or client device(s) 104. The one or more player(s) 102 may interact with the one or more other elements of the environment 100 via corresponding respective player accounts.

The client devices 104 may be configured to render content associated with a puzzle or a video game and/or online game that incorporates a puzzle to respective players 102. This content may include video, audio, haptic, combinations thereof, or the like content components. In some cases, the client device(s) 104 may host the puzzle and/or the video game locally, where the respective player 102 interacts with his or her client device 104 locally to play the video game. In other cases, the puzzle and/or the video game may be hosted online by the online gaming system 106 and a player 102 may use their client device 104 to interact with the puzzle and/or the video game, as hosted on the online gaming system 106.

In the online gaming case, the client device(s) 104 may receive game state information from the one or more online gaming system(s) 106 that may host the online game played by the player(s) 102 of environment 100. The receiving of game state information and/or game parameters may be via one or more application program interfaces (APIs) of the online game being hosted by the online gaming systems 110. The client device(s) 104 may use the game state information to render current events (e.g., audio and video) of the online game as content. The game state information may be received by the client device(s) 104 repeatedly and/or continuously and/or as events of the online game transpire. The game state information may be based at least in part on the interactions that each of the player(s) 102 have via their client device(s) 104 responsive to events of the online game hosted by the game system(s) 110.

In online gaming mode, as events transpire in the puzzle and/or the online game, the online gaming system(s) 106 may update game state information and send that game state information to the client device(s) 104. The client device(s) 104 may accept input from respective players 102 via respective input device(s) (e.g., joysticks, touchscreens, etc.) (not shown). For example, if the players 102 are playing an online puzzle, and the player 102 wishes to place an object in a sequence, then that movement of the object may be represented in the game state information that may be sent, such as via the APIs, to each of the client device(s) 104 for rendering the event object being placed in a particular ordinal position in the sequence. In this way, the content of the puzzle and/or online game is repeatedly updated throughout game play. When the client device(s) 104 receive the game state information from the online gaming system(s) 106, the game client device(s) 104 may render updated content associated with the online game to its respective player 102. This updated content may embody events that may have transpired since the previous state of the game (e.g., the placement of the object in the sequence).

The client device(s) 104 may be any suitable device, including, but not limited to a Sony Playstation® line of systems, a Nintendo Switch® line of systems, a Microsoft Xbox® line of systems, any gaming device manufactured by Sony, Microsoft, Nintendo, or Sega, an Intel-Architecture (IA)® based system, an Apple Macintosh® system, a netbook computer, a notebook computer, a desktop computer system, a set-top box system, a handheld system, a smartphone, a personal digital assistant, combinations thereof, or the like. In general, the game client device(s) 104 may execute programs thereon to host the deployed puzzle and/or interact with the online gaming system(s) 106 to render puzzle content based at least in part on game state information received from the online gaming system(s) 106. Additionally, the client device(s) 104 may receive indications of player input (e.g., player intended actions) and host the puzzle appropriately when played in a local fashion. When the puzzle is played online, the client device 104 may send indications of player inputs to the online gaming system(s) 106. Game state information and player input information and/or parameters may be shared between the game client device(s) 104 and the game system(s) 106 using APIs.

The online gaming system(s) 106 may receive inputs (e.g., parameters representative of player inputs) from various players 102 via API calls to the APIs and update the state of the online game based thereon. As the state of the online game is updated, the state information and/or updates may be sent the various client system(s) 104 for rendering online game content to players 102. In this way, the online gaming system(s) 106 host the online puzzle. Regardless of whether the puzzle is hosted locally, by the client device 104, or remotely, by the online gaming system(s) 106, the puzzle has been validated and deployed for play by players 102.

According to the disclosure herein, the puzzle validation system(s) 110 may have validated and/or provided statistical data about the puzzle prior to its deployment for use by players 102. The puzzle validation system(s) 110 may receive a variety of information about the puzzle to be validated from a developer device with which a developer 114, such as the developer 114 who created the puzzle, may interact. The puzzle validation system(s) 110 may store the puzzle validation information and/or puzzle statistics in a puzzle statistics datastore 116. The puzzle validation system(s) 110 may further provide puzzle validation information and/or puzzle statistics to the developer device 112 for the developer 114 to consider.

The developer device 112 may provide the puzzle validation system(s) 110 with any suitable variety of information about the puzzle to be validated to enable the validation process. This information about the puzzle may include, but is not limited to, a puzzle definition 118, a puzzle objective 120, puzzle constraint(s) 122, candidate actions 124, a search space 126, combinations thereof, or the like. The puzzle definition 118 may refer to the type of puzzle, such as puzzle that requires the player 102 to select an advantageous combination of objects from a larger selection of objects. The puzzle definition 118 may define a variety of descriptors of the puzzle, such as its topography and/or other general rules of the puzzle. The puzzle objective 120 may indicate the goal of the puzzle, such as minimize cost or maximize a puzzle score. A numerical (e.g., score of 78), or otherwise descriptive description (e.g., “GOOD PERFORMANCE”) of performance on the puzzle, of a player 102 may be based at least in part on how well the player 102 may have achieved the puzzle objective 120 of the puzzle. The puzzle constraint(s) 122 may define the rules of the puzzle. These rules, in examples of the disclosure, may be requirements or non-optional rules for solving the puzzle. Thus, if the puzzle constraint (s) 122 of the puzzle are violated, then the corresponding attempted solution is not a valid solution to the puzzle. The candidate actions 124 of the puzzle may define the actions that can be performed by a player 102 of the puzzle. For example, in the context of the puzzle involving arrangements of objects, the candidate actions 124 may include the operation of selecting a particular object for a particular topographical position of the puzzle. The search space 126 of the puzzle is the entirety of all options of actions that can be taken in the process of solving the puzzle In other words, the search space 126 includes all permutations of possible objects and/or actions. It is this search space 126 within which viable and/or near-optimal solutions are to be searched by the mechanisms disclosed herein.

According to examples of the disclosure, the puzzle validation system(s) 110 may generate one or more initial solutions to a puzzle that is to be validated. The initial solutions may be generated, in some cases, by determining a path for solving the puzzle. The path, in this context, may be a sequence of locations, corresponding to actions, of the puzzle that is to be filled, as candidate actions 124, with an object from the search space 126. Thus, the path describes the order in which portions of the puzzle is to be solved. The puzzle validation system(s) 110 may, in some examples, select the path for the puzzle randomly. The puzzle validation system(s) 110 may then identify for each step of the path, a subset of the search space 126 that can be applied to that step of the current step of the path. Once a step of the path, by way of object or action, is defined the puzzle validation system(s) 110 may move on to determine another subset of the search space 126 that allows a valid solution of the puzzle From that subset of the search space 126, the next step of the path is defined. This process may be continued by the puzzle validation system(s) 110 until all of the elements of the path are defined, resulting in a valid solution to the puzzle to be validated. The initial solution finding mechanism may then be repeated until a desired number of initial solutions are determined. It should be understood that by using the aforementioned mechanism, the initial set of solutions will be valid solution, in that the solutions do not violate the puzzle constraints 122. However, the initial solutions to the puzzle may not yet be optimal or near-optimal solutions to the puzzle.

The puzzle validation system(s) 110 may use the initial solutions to the puzzle to optimize the solutions using a heuristic mechanism. For example, the puzzle validation system(s) may use aspects of genetic algorithms, or evolutionary algorithms, to find an optimal or near-optimal solution to the puzzle that is to be validated. The evolutionary algorithm may employ techniques of biologic natural selection to efficiently search an objective (e.g., puzzle score) optimization space that may not be amenable to search by analytic, iterative, or other methods. In examples, the search variables and/or decision variable, such as the placement of objects in a puzzle, may be organized as a data structure that resembles genes in a chromosome or data elements in a data array. In examples of the disclosure, the decision variables of the optimization problem (e.g., puzzle score improvement) may be organized as a chromosome with genes representing the decision variables that are to be evaluated and/or optimized according to the objective, or alternatively multiple objectives, of the optimization problem. In other words, the solution may be represented as a data structure having the various decision variables representing selection elements of the puzzle.

Upon organizing the search variables, the puzzle validation system(s) 110 may perform the evolutionary algorithm to generate child chromosomes, from parent chromosomes (e.g., the initial solutions in the first round of optimization). Therefore, in examples of the disclosure, the “children” to evaluate in any given generation may be based, at least in part on the “parents” or a subset thereof, from the previous generation. The evolutionary algorithm may be configured to evaluate the chromosomes (e.g., puzzle performance metric, score, cost, etc.) from any given generation, based at least in part on the corresponding respective performance on the objective that is being used to evaluate the optimization problem. In other words, the puzzle validation system(s) 110 may be configured to determine the score corresponding to any valid solution of the puzzle.

The valid solutions (e.g., in the form of chromosomes) may be evaluated for the puzzle objective by any suitable mechanism, such as a puzzle evaluation function or any other mechanism by which the puzzle solution would be evaluated when the puzzle is deployed for use by players 102. The puzzle validation system(s) 110, may further be configured to select those chromosomes (e.g., solutions) that display the best performance according to the puzzle objective, in any given generation and use those chromosomes to generate children by crossover. The crossover operation may generate a child chromosome by selecting, such as in a pseudo-random manner, genes from the parent chromosomes to populate the child chromosome. In other words, the child chromosome may inherit each of its genes from one of its parent chromosomes. In some alternate cases, more than two (e.g., three) chromosomes may serve as parents to a child chromosome. In some cases, the parent chromosomes may be selected based at least in part on their performance and/or difference with the other parent chromosome(s). Crossover may introduce diversity, while preserving as-yet known advantageous genes, in the population of solutions to be evaluated and considered within the search space to arrive at an optimal, or near-optimal, solution.

The puzzle validation system(s) 110 may further be configured to introduce mutations (e.g., random or pseudo-random changes in one or more genes of a child chromosome) to introduce further diversity of potential solutions within the search space for the purposes of selecting a relatively optimized solution set (e.g., puzzle solution) in accordance with the identified objectives of the optimization (e.g., puzzle score). Thus, the mutation operation introduces diversity into a child population that is not inherited from the parent chromosomes. This diversity may provide the ability to evaluation portions of the search space 126 that had not been evaluated in the previous generations of the solution population.

When new child solutions are generated using the biological-styled processes described above, a check for feasibility may be performed. In other words, the puzzle validation system(s) 110 may be configured to determine, using the puzzle constraints 122 to determine whether child chromosomes are valid solutions (e.g., solutions where all of the rules of the puzzle are met). If a potential solution (e.g., a child chromosome) is not feasible, then in some examples of the disclosure, a healing process may be performed. This healing process, in some examples of the disclosure, may be similar to the operation of finding the initial solutions to the puzzle. The puzzle validation system(s) 110 may be configured to identify an invalid child chromosome in a gene-by-gene basis and flag gene(s) that violate the puzzle constraints 122. The puzzle validation system(s) 110 may then “heal” the invalid solution by changing the value of the one or more gene(s) that violate the puzzle constraints 122. In alternative examples of the disclosure, potential solutions that are found to be not feasible may be eliminated from the population of solutions that are to be evaluated for puzzle solution optimization. In other words, in this alternative example, the invalid child solutions may not be retained in the population that is evaluated or retained in the solution population for further evolution.

The optimization operations (e.g., evaluation, selection, crossover, mutation, and/or healing) may be repeated from one generation to the next, until a stopping criterion/criteria is reached. The stopping criterion may entail a determination that performance improvements (e.g., improvements in the puzzle score) has stopped from one generation to the next or is below a threshold level from one generation to the next. In other words, the puzzle validation system(s) 110 may determine that no significant improvements in the objective is being achieved by continuing the heuristic optimization, and therefore, the optimization should be stopped. The stopping criteria may further entail performing the optimization for a predetermined number of generations (e.g., 100 generations). When the stopping criterion is reached, the puzzle validation system(s) 110 may present the best solution(s) as optimal or near-optimal solutions.

The puzzle validation system(s) 110 may further be configured to determine one or more statistics related to the puzzle being validated. The statistics may be of any suitable type, such as a metric associated with an near-optimal solution (e.g., a high score), a metric associated with an average solution (e.g., an average score), a binary indication of whether the puzzle is solvable, or the like. The statistics may also provide an indication of how hard or easy it might be to achieve a near-optimal solution. For example, the puzzle validation system(s) 110 may provide an indication of how many generations it took to converge to the near-optimal solution as an indicator of difficulty of providing the near-optimal solution to the puzzle. It should be noted that without evaluating the entirety of the search space 126 of the puzzle to be validated, it may not be possible to definitively identify the most optimal solution to the puzzle. As discussed herein, evaluating the entirety of the search space 126 of these puzzles to be validated may be intractable, or at least impractical. As a result, the terminology of near-optimal solution, as used herein, refers to the most optimal solution found using the techniques discussed herein.

As discussed herein, the puzzles to be validated, using the techniques described herein, may include a combination of linear and nonlinear constraint types, which present an NP hard problem to validate. Automatic validation, as disclosed herein, of these types of puzzles provides a significant time savings and a boost in puzzle quality when compared to a manual approach. In addition, automation allows puzzle designers to estimate different properties of the puzzle, such as its difficulty, increase the variety of constraints seen across different puzzles, and even personalize puzzles to the taste of a specific player.

Such puzzles, as described herein, can and often do have relatively large search spaces 126 with multiple possible solutions. As a result, classical combinatorial search approaches quickly become intractable when applied to the task of solving these puzzles. Furthermore, quadratic asymmetric constraints in some of these puzzles make conventional approaches to solving puzzles unusable. The techniques described herein may be applied to standalone puzzles or those puzzles embedded in video games. With respect to the puzzles embedded in video games, the puzzles come in a variety of forms where a player has to fulfill a task in the video game environment employing logic and knowledge about the game to satisfy certain rules while optimizing performance (e.g., minimizing the cost of the completion). For example, this may require the player to find an optimal path, unlock a scene in a specific order using hints, or fill up a board with selected items that satisfy a set of requirements. Such puzzles are enjoyable to play and can also allow players to advance in the video game by providing rewards upon their completion. From the game designing perspective, puzzle minigames affect the economy of games where items can be gained or bought with in-game currency. Unlike more traditional logic puzzles like Sudoku, crosswords, Minesweeper, Solitaire, the towers of Hanoi, etc., where the rules of the games are usually predefined and static, puzzles in video games have quite a variety of constantly changing constraints that can be both linear and quadratic. Even more, there are usually multiple solutions to the same puzzles Those puzzles are designed by developers 114 and game creators who have expert knowledge of the game and its attributes. These puzzles, therefore, are often designed with the high level of variability and with multiple difficulty levels often customized to the skill level of the player.

In these types of puzzles (e.g., both standalone and embedded in a video game) and associated solutions, analytical methods (e.g. Lagrange multipliers, etc.), iterative convergence methods (e.g. Newton's method, etc.), and/or methods that rely on relatively high degree of a priori knowledge of trade-offs in the search space may not be as effective at arriving at an optimized solution as the heuristic techniques, such as evolutionary algorithms, as described herein. Although the puzzle validation system(s) 110 is discussed herein, are discussed in the context of the techniques disclosed herein, it will be appreciated that any suitable system for implementing a heuristic optimization, such as the developer device 112 may be used to find initial solutions to the puzzle and/or find near-optimal solutions to the puzzle, in accordance with examples of the disclosure.

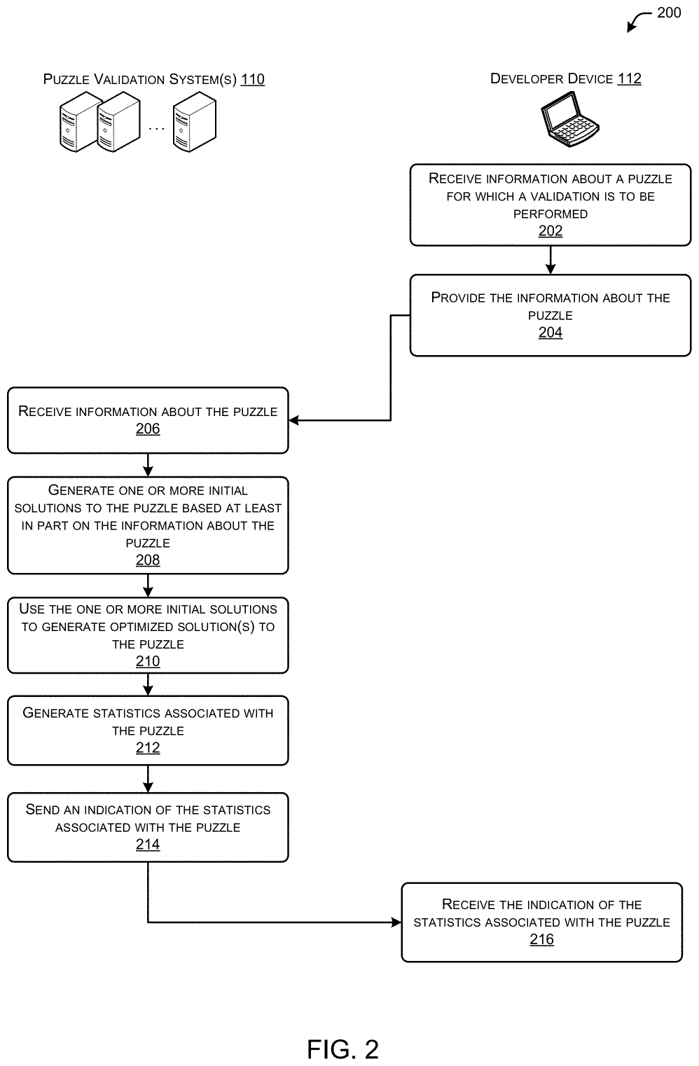

FIG. 2 illustrates a flow diagram of an example method by which a puzzle is validated, in accordance with example embodiments of the disclosure. Method 200 may be performed by the puzzle validation system(s) 110 and the developer device 112, individually or in cooperation with other element(s) of environment 100. Alternatively, the method 200 may be performed on the developer device 112, individually or in cooperation with other element(s) of environment 100.

At block 202, the developer device 112 may receive information about a puzzle for which a validation is to be performed. In some cases, this information about the puzzle may be received from the developer 114. In other cases, the information about the puzzle may be received from any other suitable source, such as a database of puzzles that are to be validated. The information about the puzzle may include the puzzle definition 118, the puzzle objective 120, the puzzle constraint(s) 122, the candidate actions 124, the search space 126, combinations thereof, or the like. At block 204, the developer device 112 may provide the information about the puzzle. At block 206, the puzzle validation system(s) 110 may receive the information about the puzzle.

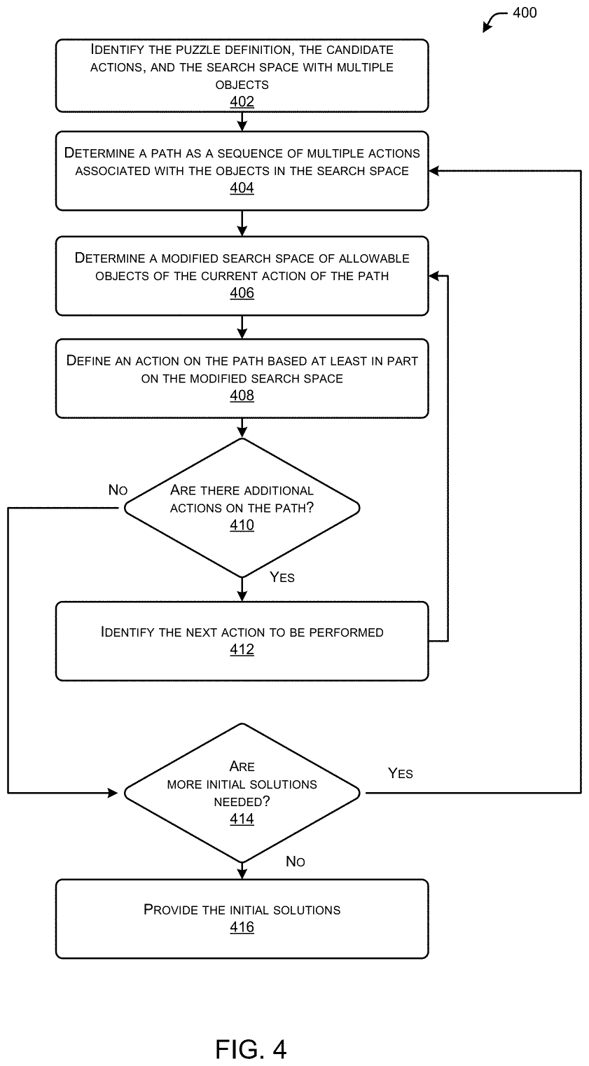

At block 208, the puzzle validation system(s) 110 may generate one or more initial solutions to the puzzle based at least in part on the information about the puzzle. Finding the initial solutions may entail determining a path for solving the puzzle. The path, in this context, may be a sequence of locations, corresponding to actions, of the puzzle that must or is to be filled, as candidate actions 124, with an object and location combination from the search space 126. Thus, the path describes the order in which portions of the puzzle is to be solved. The puzzle validation system(s) 110 may, in some examples, select the path for the puzzle randomly. The puzzle validation system(s) 110 may then identify for each step of the path, a subset of the search space 126 that can be applied to that step of the current step of the path. Once a step of the path, by way of object or action, is defined, the puzzle validation system(s) 110 may move on to the next step of the path to determine another subset of the search space 126 that allows a valid solution of the puzzle From that subset of the search space 126, the next step of the path is defined. This process may be continued by the puzzle validation system(s) 110 until all of the elements of the path are defined, resulting in a valid solution to the puzzle to be validated. The initial solution finding mechanism may then be repeated until a desired number of initial solutions are determined. It should be understood that by using the aforementioned mechanism, the initial set of solutions will be valid solutions, in that the solutions do not violate the puzzle constraints 122. However, the initial solutions to the puzzle may not yet be optimal or near-optimal solutions to the puzzle. This process is described in greater detail in conjunction with FIG. 4 herein.

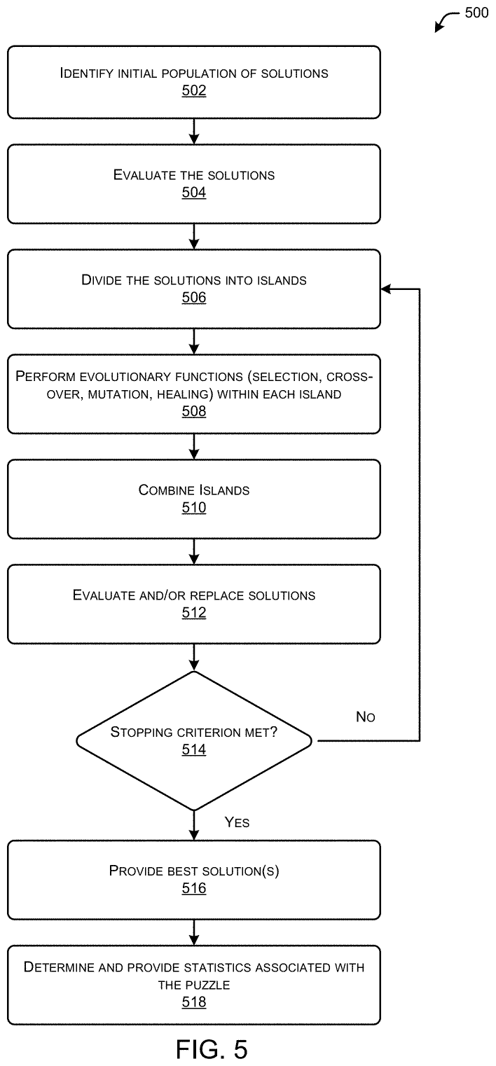

At block 210, the puzzle validation system(s) 110 may use the one or more initial solutions to generate optimized solution(s) to the puzzle. For example, the puzzle validation system(s) may use aspects of genetic algorithms, or evolutionary algorithms, to find an optimal or near-optimal solution to the puzzle that is to be validated. The evolutionary algorithm may employ techniques of biologic natural selection to efficiently search an objective (e.g., puzzle score) optimization space that may not be amenable to search by analytic, iterative, or other methods. This process is described in greater detail in conjunction with FIG. 5 herein.

At block 212, the puzzle validation system(s) 110 may generate statistics associated with the puzzle. The statistics may be of any suitable type, such as a metric associated with an near-optimal solution (e.g., a relatively high score), a metric associated with an average solution (e.g., an average score), a binary indication of whether the puzzle is solvable, or the like. The statistics may also provide an indication of how hard or easy it might be to achieve a near-optimal solution. For example, the puzzle validation system(s) 110 may provide an indication of how many generations it took to converge to the near-optimal solution as an indicator of difficulty of providing the near-optimal solution to the puzzle.

At block 214, the puzzle validation system(s) may send an indication of the statistics associated with the puzzle. At block 216, the developer device 112 may receive the indication of the statistics associated with the puzzle. The statistics and/or the solutions may further be analyzed before deploying the puzzle for game play by players 102.

It should be noted that some of the operations of method 200 may be performed out of the order presented, with additional elements, and/or without some elements. Some of the operations of method 200 may further take place substantially concurrently and, therefore, may conclude in an order different from the order of operations shown above.

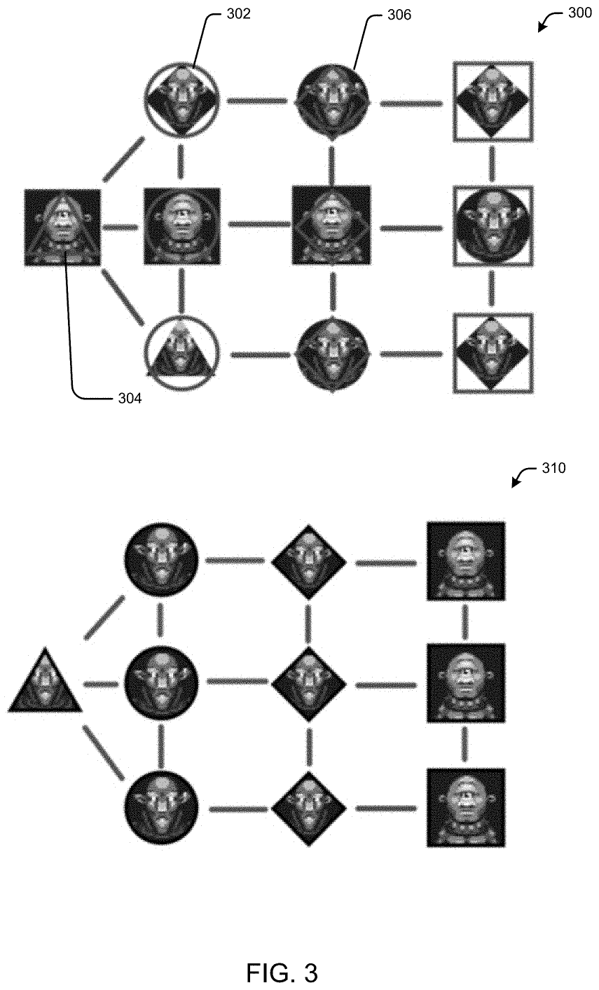

FIG. 3 illustrates an example puzzle that may be validated, in accordance with example embodiments of the disclosure. Two solutions 300, 310 are shown of the example puzzle. This type of puzzle may be a “Party Building Puzzle,” where a player 102 is tasked with selecting and filling out a combat formation with different in-game items, such as goblins 302, 306 and ores 304 such that the resultant party obeys the puzzle's requirements and is strong to defeat various battles in the video game in which the puzzle is embedded.

The requirements of this puzzle (e.g., puzzle constraints 122) may be to select and arrange items in a 10-item graph such that there are at least 7 goblins 302, 306 and at least two types of monsters (e.g., goblins 302, 306, orcs 304, etc.). The solutions 300, 310 includes arrangement of those game items, such as the example goblins 302, 306 and orcs 304 in a formation graph. The properties of the items affect how well the item fits its position and how strong the links between the neighbors are, with better fit and stronger links resulting in a higher “synergy metric.” Having the more monsters that are of the same type may increase the synergy metric of the puzzle (e.g., the puzzle objective 120). The solution 310, therefore, performs better, from a synergy metric standpoint, than the solution 300, since there are more goblins 302, 306 who are adjacent to each other in solution 310.

It should be noted that both the solutions 300, 310 are valid, as neither solution presents any violation of the puzzle constraints 122. However, the solution 310 is better performing than solution 300 according to the puzzle objective 120 (e.g., synergy metric). It should also be noted that with a larger graph and a much greater number of candidate actions 124 and/or objects (e.g., types of monsters) for placement, this puzzle may present a relatively large search space 126. This is one of many types of puzzles that can be validated according to the disclosure herein. Additionally, the disclosure herein enables determining near-optimal solutions to this and other puzzles. Further still, the disclosure herein enables determining one or more statistics associated with this and other puzzles.

FIG. 4 illustrates a flow diagram of an example method 400 for determining an initial population of solutions to a puzzle, in accordance with example embodiments of the disclosure. Method 400 may be performed by the puzzle validation system(s) 110 or the developer device 112, individually or in cooperation with other element(s) of environment 100. In some examples of the disclosure, method 400 may be an implementation of operations of block 208 of method 200, as depicted in FIG. 2.

At block 402, the puzzle validation system(s) 110 may identify the puzzle definition 118, the candidate actions 124, and the search space 126 with multiple objects and/or candidate actions 124. Collectively, this data may be referred to as the information about the puzzle to be validated. As indicated in method 200 of FIG. 2, in some cases, the information about the puzzle may be received from the developer device 112. This information about the puzzle is used by the puzzle validation system(s) 110 to find one or more valid solution(s) to the puzzle to be validated.

At block 404, the puzzle validation system(s) 110 may determine a path, as a sequence of multiple actions associated with the objects in the search space 126. The path, in this context, may be a sequence of locations, corresponding to actions, of the puzzle that must or is to be filled, as candidate actions 124, with an object from the search space 126. Thus, the path describes the order in which portions of the puzzle is to be solved. The puzzle validation system(s) 110 may, in some examples, select the path for the puzzle randomly.

At block 406, the puzzle validation system(s) 110 may determine a modified search space of allowable objects of the current action of the path. In other words, the puzzle validation system(s) 110 may then identify for each step of the path, a subset of the search space 126 that can be applied to the current step of the path. The modified search space may include a collection of objects and/or actions that can be allocated and/or defined for the current position on the path without violating any constraints. It is this sequential selection of only valid objects and/or actions for every step of the puzzle that ensures that the solutions determined according to method 400 are valid. The puzzle validation system(s) 110, for every step of the path, may identify which actions (e.g., placement of objects in particular positions of the puzzle) have already been finished and which actions are still to be performed. The puzzle validation system(s) 110 may then identify which rules of the puzzle, resulting in puzzle constraints 122, have already been fulfilled and which rules still need to be satisfied. Based at least in part on the defined actions of previous steps of the path and the remaining steps of the path available to fulfill any remaining rules of the puzzle, the puzzle validation system(s) 110 may identify which objects and/or actions are available at the current step of the path to providing a valid solution to the puzzle.

At block 408, the puzzle validation system(s) 110 may define an action on the path based at least in part on the modified search space. This definition may entail selection of one of the allowed objects, as determined in the operations of block 406, to the current step of the traversal path for providing a solution to the puzzle In some cases, the definition of the action (e.g., selection of an object for placement at a particular location of the puzzle) may entail a random selection from the allowed objects.

At block 410, the puzzle validation system(s) 110 may determine if there are additional actions on the path. If there are additional actions on the path, then at block 412, the puzzle validation system(s) 110 may identify the next action to be performed. Next, the method 400 may return to block 406, where a new modified search space is determined for the next action to be performed. In this way, the method 400 may cycle back to determine the allowable objects of the current action of the path and then definition of that action in an iterative manner until the entirety of the path is traversed to provide a valid solution to the puzzle. The solution generated by this mechanism is valid (e.g., the solution does not violate any of the puzzle constraints 122) because only valid actions and/or objects are allowed along every step of the path.

If however, at block 410, it is determined that there are no additional actions on the path, then the method 400 may advance to block 414, where the puzzle validation system(s) 110 determines whether there are more initial solutions needed. When the method 400 was commenced, in some cases, the number of initial solutions desired may be specified. If the number of initial solutions is less than the desired number of initial solutions, then the puzzle validation system(s) 110 may determine that additional initial solution(s) are needed. If it is determined that more initial solutions are not needed, then at block 416, the puzzle validations system(s) 110, at block 416, may provide the initial solutions. The initial solutions are the valid solutions, such as in the form of chromosomes, that were generated by way of method 400. If, however, it is determined, at block 414, that additional initial solutions are to be generated, then the method 400 may return to block 404 determine a new path and a new associated initial solution to the puzzle.

The method 400 may be performed by the client devices 104 and/or the online gaming system(s) 106, individually or in cooperation with one or more other elements of the environment 100. The method 400 may be an example process for the operations of block 216 of method 200 of FIG. 2.

It should be noted that some of the operations of method 400 may be performed out of the order presented, with additional elements, and/or without some elements. Some of the operations of method 400 may further take place substantially concurrently and, therefore, may conclude in an order different from the order of operations shown above.

FIG. 5 illustrates a flow diagram of an example method 500 for determining one or more optimized solutions of a puzzle and/or statistics associated with the puzzle, in accordance with example embodiments of the disclosure. Method 500 may be performed by the puzzle validation system(s) 110 or the developer device 112, individually or in cooperation with other element(s) of environment 100. In some examples of the disclosure, method 500 may be an implementation of operations of block 210 and/or 212 of method 200, as depicted in FIG. 2.

At block 502, the puzzle validation system(s) 110 may identify an initial population of solutions. This initial population of solutions may have any suitable number of valid solutions, such as in the form of chromosomes, that can be used as a starting point of the heuristic optimization of method 500. In other words, the initial population may represent a starting point, such as a best guess, prior to the benefits of the optimization, as described herein. In some cases, the initial solution(s) may be obtained via the operations of method 400, as depicted in FIG. 4. Alternatively, the initial solution(s) may include one or more solutions to the puzzle, as solved by a human, and provided to the puzzle validation system(s) 110 for the purposes of generating an near-optimal solution.

At block 504, the puzzle validation system(s) 110 may evaluate the solutions. The puzzle validation system(s) 110 may use any suitable function to evaluate the chromosomes according to any suitable performance metric (e.g., puzzle performance metric, score, cost, etc.). In some cases, the puzzle validation system(s) 110 may evaluate the solutions in the same way that solutions may be evaluated when deployed for use by players 102.

At block 506, the puzzle validation system(s) 110 may divide the solutions into islands. In some cases, dividing the solutions into islands may result in greater diversity of the solution chromosomes, which in turn may allow for exploration of a greater portion of the search space 126. The solutions may be divided according to their performance, in some cases. In other cases, the solutions may be divided into islands according to their similarity in the decision variable space. For example, two chromosomes that have 20 genes in common may be islanded together, while another chromosome that shares only 5 common genes may be allocated to another island. It will be appreciated that partitioning the solutions in to different islands according to similarity may use any variety of techniques for comparing two different chromosomes, such as a dot-product of the chromosomes, a cosine similarity of the chromosomes, or the like. In some cases, each of the islands may be optimized by different cores of a processor or by different processors of the puzzle validations system(s) 110. Partitioning the islands to different processing elements may improve the efficiency and/or parallel processing of the heuristic optimization. In some cases, this operation may be optional, and instead, all of the solutions may be evaluated without partitioning them into islands.

At block 508, the puzzle validation system(s) 110 may perform evolutionary functions, such as selection, crossover, mutation, and/or healing, within each island. The puzzle validation system(s) 110 may select pairs of parent chromosome data structures from the population of parent chromosome data structures. The selection process may be based on finding the best performing (e.g., most fit) solution, according to the puzzle performance metric, within each island. In some cases, the selection process may select, and mate, different performing, and/or most spaced (in the decision variable space) solutions. In some example cases, tournament selection processes may be implemented to select solutions for mating. The puzzle validation system(s) 110 may perform the evolutionary algorithm to generate child chromosomes, from parent chromosomes (e.g., the initial solutions in the first round of optimization). Therefore, in examples of the disclosure, the “children” to evaluate in any given generation may be based, at least in part on the “parents” or a subset thereof, from the previous generation.

The chromosomes in selected pairs of parent chromosome data structures may be subject to one or more evolutionary operators to generate a plurality of child chromosome data structures, according to examples of the disclosure. A crossover evolutionary operator may be implemented in which a portion of the parameter values or “gene” values may be exchanged between chromosomes in selected pairs of parent chromosome data structures to generate new pairs of chromosome data structures. In an examples of the disclosure, the crossover evolutionary operation may be capable of performing crossover using integer or non-integer numbers (e.g., double precision numbers, etc.), binary representation of numbers, letters, and/or symbols. The resultant child solutions may further be subjected to a mutation evolutionary operator in which a parameter value or gene value (e.g., an evolved variable value) in a chromosome may be varied or otherwise changed to another value by a mutation.

It will be appreciated that the crossover evolutionary operator and the mutation evolutionary operator need not necessarily be applied to every gene of each of the chromosome data structures. In an example of the disclosure, only a portion or percentage of the received chromosomes in the chromosome data structures may have their genes crossed-over or mutated, respectively. The respective portions or percentages that are crossed-over and/or mutated may be predetermined or dynamically varied during operation of the evolutionary algorithm, according to examples of the disclosure. For example, a first predetermined portion or percentage (e.g., 50%-80%) of the chromosomes of the chromosome data structures may have genes that are crossed over while a second predetermined portion or percentage (e.g., 1%-3%) of the chromosome data structures may have genes that are mutated. On the other hand, for dynamic variations, the respective portions or percentages that are crossed-over and/or mutated may be increased or decreased during runtime to increase or decrease the rate of evolutionary progress as desired or required.

After the crossover and mutation operations are performed to produce child chromosomes, it will be appreciated that some of the child chromosomes may be invalid. In other words, some of the child chromosomes may violate one or more puzzle constraints 122. At this point, the puzzle validation system(s) 110 may heal the child chromosomes that are not valid. This healing operation may include determining, along a path, a progression of the genes on the path, similar to the initial solution generation method, as described in conjunction with FIG. 4. When a gene that violates the puzzle constraints 122 is encountered, that gene may be changed to comply with the puzzle constraints 122. In this way, the whole path, encompassing all of the genes, may be traversed to change all of the invalid genes of the chromosome being healed. At this point, the child chromosome is healed and can be evaluated and subsequently used to produce child chromosomes in the next generation of the heuristic process.

At block 510, the puzzle validation system(s) 110 may combine the islands. In those cases, where different islands were optimized by different cores of the processor or by different processors of the puzzle validation system(s) 110, the island recombination operation may involve one of the cores or one of the processors to collect optimization information for each of the other islands from each of the other cores or processors. In some cases, this operation may be optional, and instead, all of the solutions may be evaluated without partitioning them into islands or subsequently recombining the islands.

At block 512, the puzzle validation system(s) 110 may evaluate and/or replace solutions. The new population of child chromosomes, resulting from the operations of 506, 508, and 510, may be evaluated in a manner similar to what was performed with the parent chromosomes in the operations of block 504. After evaluation, a subset of the available chromosomes (parents and children) may be retained, based at least in part on their performance and/or their diversity. For example, the best performing (e.g., highest score) chromosomes up to a predetermined number may be retained and for producing subsequent generations. In this way, when a child chromosome is retained and a parent chromosome is removed from the subsequent generation, the parent chromosome is replaced with the child chromosome.

At block 514, the puzzle validation system(s) 110 may determine whether a stopping criterion is met. The stopping criterion may entail a determination that performance improvements (e.g., improvements in the puzzle score) has stopped from one generation to the next or is below a threshold level from one generation to the next. In other words, the puzzle validation system(s) 110 may determine that no significant improvements in the objective is being achieved by continuing the heuristic optimization, and therefore, the optimization should be stopped. The stopping criteria may further entail performing the optimization for a predetermined number of generations (e.g., 100 generations). If the stopping criterion/criteria is met, then the method 500 may proceed to block 516, where the puzzle validation system(s) 110 provide the best solution(s), such as to the developer device 112. These best solution(s) may represent optimal and/or near-optimal solutions to the puzzle. The terminology of near-optimal solution, as used herein, refers to the most optimal solution found by performing the method 500. If, on the other hand, the stopping criterion/criteria is not met at block 514, then the method 500 may return to block 506 to perform an optimization over another generation.

At block 518, the puzzle validation system(s) 110 may determine and provide statistics associated with the puzzle. The statistics may be of any suitable type, such as a metric associated with an near-optimal solution (e.g., a relatively high score), a metric associated with an average solution (e.g., an average score), a binary indication of whether the puzzle is solvable, or the like. The statistics may also provide an indication of how hard or easy it might be to achieve a near-optimal solution. For example, the puzzle validation system(s) 110 may provide an indication of how many generations it took to converge to the near-optimal solution as an indicator of difficulty of providing the near-optimal solution to the puzzle.

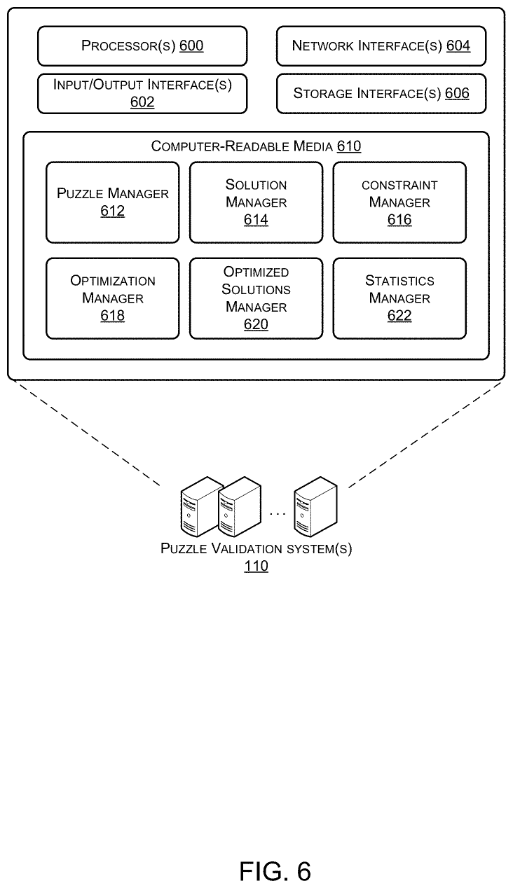

FIG. 6 illustrates a block diagram of an example puzzle validation system(s) 110 that may validate a puzzle, in accordance with example embodiments of the disclosure. The puzzle validation system(s) 110 may include one or more processor(s) 600, one or more input/output (I/O) interface(s) 602, one or more network interface(s) 604, one or more storage interface(s) 606, and computer-readable media 610.

In some implementations, the processors(s) 600 may include a central processing unit (CPU), a graphics processing unit (GPU), both CPU and GPU, a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip system(s) (SOCs), complex programmable logic devices (CPLDs), etc. Additionally, each of the processor(s) 600 may possess its own local memory, which also may store program modules, program data, and/or one or more operating system(s). The one or more processor(s) 600 may include one or more cores.

The one or more input/output (I/O) interface(s) 602 may enable the puzzle validation system(s) 110 to detect interaction with a user and/or other system(s), such as developer device 112. The I/O interface(s) 602 may include a combination of hardware, software, and/or firmware and may include software drivers for enabling the operation of any variety of I/O device(s) integrated on the puzzle validation system(s) 110 or with which the puzzle validation system(s) 110 interacts, such as displays, microphones, speakers, cameras, switches, and any other variety of sensors, or the like.

The network interface(s) 604 may enable the puzzle validation system(s) 110 to communicate via the one or more network(s). The network interface(s) 604 may include a combination of hardware, software, and/or firmware and may include software drivers for enabling any variety of protocol-based communications, and any variety of wireline and/or wireless ports/antennas. For example, the network interface(s) 604 may comprise one or more of a cellular radio, a wireless (e.g., IEEE 802.1x-based) interface, a Bluetooth® interface, and the like. In some cases, the network interface(s) 604 may include radio frequency (RF) circuitry that allows the puzzle validation system(s) 110 to transition between various standards. The network interface(s) 604 may further enable the puzzle validation system(s) 110 to communicate over circuit-switch domains and/or packet-switch domains.

The storage interface(s) 606 may enable the processor(s) 600 to interface and exchange data with the computer-readable medium 610, as well as any storage device(s) external to the puzzle validation system(s) 110, such as puzzle statistics datastore 116.

The computer-readable media 610 may include volatile and/or nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, RAID storage system(s), or any other medium which can be used to store the desired information and which can be accessed by a computing device. The computer-readable media 610 may be implemented as computer-readable storage media (CRSM), which may be any available physical media accessible by the processor(s) 600 to execute instructions stored on the computer-readable media 610. In one basic implementation, CRSM may include random access memory (RAM) and Flash memory. In other implementations, CRSM may include, but is not limited to, read-only memory (ROM), electrically erasable programmable read-only memory (EEPROM), or any other tangible medium which can be used to store the desired information and which can be accessed by the processor(s) 600. The computer-readable media 610 may have an operating system (OS) and/or a variety of suitable applications stored thereon. The OS, when executed by the processor(s) 600 may enable management of hardware and/or software resources of the puzzle validation system(s) 110.

Several functional blocks having instruction, data stores, and so forth may be stored within the computer-readable media 610 and configured to execute on the processor(s) 600. The computer readable media 610 may have stored thereon a puzzle manager 612, a solution manager 614, a constraint manager 616, an optimization manager 618, an optimized solutions manager 620, and a statistics manager 622. It will be appreciated that each of the functional blocks 612, 614, 616, 618, 620, 622, may have instructions stored thereon that when executed by the processor(s) 600 may enable various functions pertaining to the operations of the puzzle validation system(s) 110.

The instructions stored in the puzzle manager 612, when executed by the processor(s) 600, may configure the puzzle validation system(s) 110 to receive information about a puzzle that is to be validated. This information may include any variety of puzzle definition 118, puzzle objective 120, puzzle constraints 122, candidate actions 124, and/or search space 126. The puzzle manager 612 also enables the processor(s) 600 to manage to operations of finding initial population of solutions and the heuristic optimization of the solutions.

The instructions stored in the solution manager 614, when executed by the processor(s) 600, may configure the puzzle validation system(s) 110 to perform the operations of obtaining the initial solutions to the puzzle that is to be validated. The processor(s) 600 are configured to determine a path, identify a modified search space for each step of the path, and define selections for each step of the path.

The instructions stored in the constraint manager 616, when executed by the processor(s) 600, may configure the puzzle validation system(s) 110 to identify if a solution is in violation of one or more puzzle constraints 122. The processor(s) 600 may be configured to identify, therefore, which solutions are invalid. The invalid solutions may be in violation of one or more rules of the puzzle to be validated.

The instructions stored in the optimization manager 618, when executed by the processor(s) 600, may configure the puzzle validation system(s) 110 to perform any suitable type of heuristic (e.g., guess-and-evaluate) algorithm to provide optimal or near-optimal solutions to the puzzle. For example, the processor(s) 600 may be configured to perform genetic/evolutionary algorithms that mimic biological operations to drive towards optimized solutions that are most fit to survive from one generation to the next. In particular, the processor(s) 600 may be configured to perform evolutionary operations, such as selection, cross over, and mutations. The processor(s) 600 may also be configured to perform healing functions to repair child populations that are initially invalid.

The instructions stored in the optimized solutions manager 620, when executed by the processor(s) 600, may configure the puzzle validation system(s) 110 to provide optimal or near-optimal solutions, such as to the developer device 112. This enables the deployment of puzzles, either as standalone puzzles or as puzzles embedded in another video game.

The instructions stored in the statistics manager 622, when executed by the processor(s) 600, may configure the puzzle validation system(s) 110 to generate and provide one or more statistics associated with the puzzle. These statistics may be associated with whether the puzzle is reasonable solvable, what is the difficulty of solving the puzzle, what are “GOOD” or “BAD” scores on the puzzle, etc.

The illustrated aspects of the claimed subject matter may also be practiced in distributed computing environments where certain tasks are performed by remote processing devices that are linked through a communications network. In a distributed computing environment, program modules can be located in both local and remote memory storage devices.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

The disclosure is described above with reference to block and flow diagrams of system(s), methods, apparatuses, and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some examples of the disclosure.

Computer-executable program instructions may be loaded onto a general purpose computer, a special-purpose computer, a processor, or other programmable data processing apparatus to produce a particular machine, such that the instructions that execute on the computer, processor, or other programmable data processing apparatus for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction that implement one or more functions specified in the flow diagram block or blocks. As an example, embodiments of the disclosure may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

It will be appreciated that each of the memories and data storage devices described herein can store data and information for subsequent retrieval. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, the databases shown can be integrated or distributed into any number of databases or other data storage devices.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system, comprising:
one or more processors; and
one or more computer-readable media storing computer-executable instructions that, when executed by the one or more processors, cause the one or more processors to:
identify a search space associated with a puzzle to be validated, the search space including one or more objects;
identify puzzle constraints associated with the puzzle;
determine a traversal path for identifying a first solution to the puzzle, the traversal path including a sequence of candidate actions;
determine, for each of the sequence of candidate actions and based at least in part on the search space and the puzzle constraints, respective modified search spaces, each of the respective modified search spaces including a subset of the one or more objects;
determine the first solution to the puzzle based at least in part on the respective modified search spaces;
generate, based at least in part on the first solution, a near-optimal solution to the puzzle;
generate one or more statistical data associated with the near-optimal solution; and
indicate, based at least in part on the one or more statistical data, that the puzzle is valid.

2. The system of claim 1, wherein the computer-executable instructions further cause the one or more processors to:
perform at least one evolutionary function on the first solution to generate a second solution to the puzzle, wherein the near-optimal solution is based at least in part on the second solution.

3. The system of claim 2, wherein the computer-executable instructions further cause the one or more processors to:
determine, based at least in part on the puzzle constraints, that the second solution is invalid; and
based at least in part on determining that the second solution is invalid, heal the second solution by changing at least one gene within the solution to generate a third solution.

4. The system of claim 3, wherein the computer-executable instructions further cause the one or more processors to:
evaluate the third solution according to a metric associated with the puzzle;
evaluate a fourth solution according to the metric associated with the puzzle;
determine, based at least the evaluation of the third solution and the evaluation of the fourth solution, that the third solution and the fourth solution are to be crossed over;
cross over the third solution and the fourth solution to generate a fifth solution, wherein the fifth solution includes a plurality of genes from one of the third solution or the fourth solution;
mutate a first of the plurality of genes; and
heal a second of the plurality of genes.

5. The system of claim 4, wherein to heal a second of the plurality of genes, the computer-executable instructions further cause the one or more processors to:
determine, based at least in part on the puzzle constraints, that the fifth solution is invalid;
identify a second traversal path, the second traversal path including the sequence of candidate actions;
sequentially traverse the second traversal path, wherein at each candidate action of the traversal path, identify whether a gene corresponding to the candidate action is invalid; and
change a respective value of each gene found to be invalid.

6. The system of claim 1, wherein to determine a traversal path, the computer-executable instructions further cause the one or more processors to:
randomly select the traversal path.

7. The system of claim 1, wherein the computer-executable instructions further cause the one or more processors to:
determine a second traversal path; and
determine a second solution to the puzzle based at least in part on the second traversal path, wherein the near-optimal solution is based at least in part on the second traversal path.

8. The system of claim 1, wherein to generate one or more statistical data associated with the near-optimal solution, the computer-executable instructions further cause the one or more processors to:
evaluate the near-optimal solution according to a metric associated with the puzzle to generate a performance value; and
provide the performance value.

9. A method, comprising:
identifying an initial population of solutions to a puzzle, the initial population including a first solution and a second solution;
determining that the first solution is associated with a first score;
determining that the second solution is associated with a second score;
determining, based at least in part on the first score and the second score, that the first solution and the second solution are to be crossed over;
crossing over the first solution and the second solution to generate a third solution, the third solution including a plurality of genes, individual ones of the plurality of genes inherited from one of the first solution or the second solution;
determining that the third solution is associated with a third score; and
providing, based at least in part on the third score, the third solution as a near-optimal solution to the puzzle.

10. The method of claim 9, wherein providing the third solution as a near-optimal solution to the puzzle further comprises:
determining, based at least in part on the third score, that a stopping criterion for a heuristic optimization is satisfied.

11. The method of claim 9, further comprising:
mutating the third solution by changing values of one or more randomly selected genes of the plurality of genes.

12. The method of claim 9, further comprising:
determining, based at least in part on a puzzle constraint, that the third solution is invalid;
identifying a traversal path for determining a valid solution to the puzzle, the traversal path including a sequence of candidate actions;
sequentially traversing the traversal path, wherein at each candidate action of the traversal path, identifying whether a gene corresponding to the candidate action is invalid; and
changing a respective value of each gene found to be invalid.

13. The method of claim 9, wherein determining that the third solution is associated with a third score further comprises:
identifying an evaluation function for evaluating solutions to the puzzle; and
evaluating the third solution based at least in part on the evaluation function.

14. The method of claim 9, identifying the initial population of solutions to the puzzle further comprises:
identifying a search space associated with the puzzle;
identifying puzzle constraints associated with the puzzle;
determining a traversal path including a sequence of candidate actions;
determining, for each of the sequence of candidate actions and based at least in part on the search space and the puzzle constraints, respective modified search spaces, each of the respective modified search spaces including a one or more objects; and
determine the first solution to the puzzle based at least in part on the respective modified search spaces.

15. The method of claim 9, further comprising:
providing an indication that the puzzle is valid.

16. The method of claim 9, further comprising:
generating, based at least in part on the third solution, one or more statistics associated with the puzzle; and
providing the one or more statistics associated with the puzzle.

17. A system, comprising:
one or more processors; and
one or more computer-readable media storing computer-executable instructions that, when executed by the one or more processors, cause the one or more processors to:
determine a traversal path for identifying a first solution to a puzzle to be validated, the traversal path including a sequence of actions;
identify a first action of the sequence of actions;
determine a plurality of objects associated with the first action, the plurality of objects representing valid choices for selection for a portion of the puzzle associated with the first action;
select a first object from the plurality of objects as the first action;
identify a second action of the sequence of actions;
determine a second plurality of objects associated with the second action, the second plurality of objects representing valid choices for selection for a second portion of the puzzle associated with the second action;
select a second object from the plurality of objects as the second action; and
generate the first solution based at least in part on the first object and the second object.

18. The system of claim 17, wherein the computer-executable instructions further cause the one or more processors to:
determine a second traversal path for identifying a second solution to the puzzle, the second traversal path including a second sequence of actions;
identify a third action of the second sequence of actions;
determine a third plurality of objects associated with the third action, the third plurality of objects representing valid choices for selection for a portion of the puzzle associated with the third action;
select a third object from the third plurality of objects as the third action;
identify a fourth action of the second sequence of actions;
determine a fourth plurality of objects associated with the fourth action, the fourth plurality of objects representing valid choices for selection for a fourth portion of the puzzle associated with the fourth action;
select a fourth object from the plurality of objects as the fourth action; and
generate the second solution based at least in part on the first object and the second object.

19. The system of claim 18, wherein the computer-executable instructions further cause the one or more processors to:
generate, based at least in part on the first solution and the second solution, a near-optimal solution to the puzzle; and
generate one or more statistical data associated with the near-optimal solution.

20. The system of claim 19, wherein the computer-executable instructions further cause the one or more processors to:
deploy the puzzle based at least in part on at least one of: the first solution, the near-optimal solution, or the one or more statistical data.
